(19) United States
(12) Patent Application Publication
(10) Pub. No.: US 2026/0179932 A1
(43) Pub. Date: Jun. 25, 2026

(54) ELECTRODE, A METHOD FOR MANUFACTURING THE SAME, AND AN ANODE-FREE ALL-SOLID-STATE BATTERY INCLUDING THE SAME

(71) Applicants: HYUNDAI MOTOR COMPANY, Seoul (KR); KIA CORPORATION, Seoul (KR); IUCF-HYU (Industry-University Cooperation Foundation Hanyang University), Seoul (KR)

(72) Inventors: Ki Yoon Bae, Hwaseong-si (KR); Sang Heon Lee, Hwaseong-si (KR); Jong Chan Song, Hwaseong-si (KR); Sam Ick Son, Hwaseong-si (KR); Ji Young Kim, Hwaseong-si (KR); Da Young Jun, Seoul (KR); Kyu Seok Kim, Seoul (KR); Yun Jung Lee, Seoul (KR)

(73) Assignees: HYUNDAI MOTOR COMPANY, Seoul (KR); KIA CORPORATION, Seoul (KR); IUCF-HYU (Industry-University Cooperation Foundation Hanyang University), Seoul (KR)

(21) Appl. No.: 19/212,905

(22) Filed: May 20, 2025

(30) Foreign Application Priority Data
Dec. 23, 2024 (KR) 10-2024-0194642

(51) Int. Cl. H01M 4/46; H01M 4/02; H01M 4/04; H01M 10/0562

(52) U.S. Cl. CPC H01M 4/466; H01M 4/0404; H01M 10/0562; H01M 2004/021; H01M 2004/027; H01M 2300/0068

(57) ABSTRACT

An electrode includes a current collector and a coating layer located on the current collector. The coating layer includes magnesium particles, metal nanoparticles of a different kind from the magnesium particles, and a carbon material. A weight ratio of the magnesium particles to the metal nanoparticles of the different kind from the magnesium particles is 2.3 to 99.1.

### CROSS-REFERENCE TO RELATED APPLICATION

This application claims the benefit of and priority to Korean Patent Application No. 10-2024-0194642, filed in the Korean Intellectual Property Office on Dec. 23, 2024, the entire contents of which are incorporated herein by reference.

### TECHNICAL FIELD

The present disclosure relates to an electrode, a method for manufacturing the same, and an anode-free all-solid-state battery.

### BACKGROUND

Recently, anode-free lithium secondary battery systems have received a lot of attention as a next-generation energy storage device that may realize a high energy density and a high theoretical capacity. In such an anode-free lithium secondary battery system, lithium ions that are present in a cathode move to an anode through an electrolyte. The lithium ions are deposited metallic lithium and are desorbed during as a charging/discharging process, and lithium moves. In this process, an anode-free structure, in which no separate anode active material is present in the anode, may simplify a system and is advantageous in increasing an energy density.

However, an anode-free lithium secondary battery system has had many difficulties in practical implementation due to an unstable and non-uniform deposition problem of lithium. When lithium is unevenly deposited in the anode, lithium dendrites may be formed, which may cause deterioration of an interface with the electrolyte and a cell short circuit through penetration into the solid electrolyte. This problem greatly shortens the lifespan of the battery and becomes a factor that may reduce safety.

To solve this problem, an electrode, to which a magnesium material having high lithium solubility is applied, has been developed. Magnesium is attracting attention as a material that may form an alloy with lithium, and Magnesium may induce stable deposition of lithium ions. In particular, magnesium provides a high stability in an alloy with lithium and thus suppresses the formation of lithium dendrites greatly improves an interfacial stability.

However, because a magnesium material essentially has a low lithium diffusion rate, the rate capability of the all-solid-state battery may be lowered. A low diffusion rate makes it difficult for lithium ions to move during charging and discharging, which may reduce the performance of the battery under high current density conditions. This problem may act as a major obstacle to practical use.

The subject matter described in this background section is intended to promote an understanding of the background of the disclosure and thus may include subject matter that is not already known to those of ordinary skill in the art.

### SUMMARY

To solve the above-mentioned problems, there is a need to develop a new type of electrode that may supplement a low lithium diffusion rate of magnesium and improve rate capability characteristics by promoting movement of lithium ions in the electrode. The present disclosure has been made to solve the above-mentioned problems occurring in the prior art while advantages achieved by the prior art are maintained intact.

An aspect of the present disclosure provides an electrode that includes magnesium particles and metal nanoparticles of a different kind from the magnesium particles to induce a uniform expansion behavior of the electrode. Thus, deposition and desorption behaviors of lithium may be stabilized, and lifespan characteristics may be improved.

An aspect of the present disclosure also provides a method for manufacturing an electrode.

An aspect of the present disclosure also provides an anode-free all-solid-state battery.

The technical problems to be solved by the present disclosure are not limited to the aforementioned problems. Any other technical problems not mentioned herein should be clearly understood from the following description by those having ordinary skill in the art to which the present disclosure pertains.

According to an aspect of the present disclosure, an electrode includes a current collector and a coating layer located on the current collector. The coating layer includes magnesium particles, metal nanoparticles of a different kind from the magnesium particles, and a carbon material. A weight ratio of the magnesium particles to the metal nanoparticles of the different kind from the magnesium particles is 2.3 to 99.1.

The carbon material may be included in the coating layer in an amount of 0.1% by weight to 10% by weight.

The current collector may be selected from the group consisting of a copper current collector, a stainless steel current collector, an aluminum current collector, a nickel current collector, a titanium current collector, an aluminum-cadmium composite current collector, a nickel plated foil current collector, and a nickel alloy current collector.

The carbon material may be present and dispersed between the magnesium particles.

The carbon material may be selected from the group consisting of a carbon nanotube and a vapor-grown carbon fiber.

The metal nanoparticles of the different kind from the magnesium particles may be selected from the group consisting of silver nanoparticles, tin nanoparticles, zinc nanoparticles, bismuth nanoparticles, indium nanoparticles, and gallium nanoparticles.

An average particle diameter of the metal nanoparticles of the different kind of the magnesium particles may range from 30 nm to 800 nm.

A thickness of the coating layer may range from 4.0 μm to 5.0 μm.

In the coating layer, the metal nanoparticles or the metal nanoparticles of the different kind from the magnesium particles may be present and dispersed between the magnesium particles.

A thickness of the electrode may range from 14.0 μm to 15.0 μm.

According to an aspect of the present disclosure, a method for manufacturing an electrode includes manufacturing a coating solution by mixing magnesium particles, a carbon material, metal nanoparticles of a different kind from the magnesium particles, a binder, and a solvent. The method further includes forming a coating layer on a surface of a current collector by using the coating solution. The method further includes drying the coating layer at a temperature of 100° C. to 150° C. A weight ratio of the magnesium particles to the metal nanoparticles of the different kind from the magnesium particles is 2.3 to 99.1.

Drying the coating layer may be performed for 5 hours to 8 hours.

According to an aspect of the present disclosure, an anode-free all-solid-state battery includes a cathode, an anode, and a solid electrolyte layer disposed between the cathode and the anode. The cathode includes a cathode active material layer including a cathode active material. The anode is the electrode as described above. The solid electrolyte layer is disposed between the cathode active material layer and the anode.

A solid electrolyte of the solid electrolyte layer may be selected from the group consisting of a polymer electrolyte, an oxide-based solid electrolyte, and a sulfide-based solid electrolyte.

Lithium may be present and dispersed between the magnesium particles when the anode-free all-solid-state battery is charged and discharged 100 times or more than 100 times.

### BRIEF DESCRIPTION OF THE DRAWINGS

The above and other objects, features, and advantages of the present disclosure should be more apparent from the following detailed description taken in conjunction with the accompanying drawings, in which:

FIG. 1 illustrates a schematic diagram of an anode-free all-solid-state battery according to one embodiment of the present disclosure;

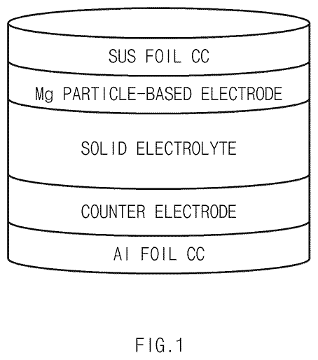

FIG. 2 is a schematic diagram of an electrode of a first embodiment, a first comparative example, and a second comparative example;

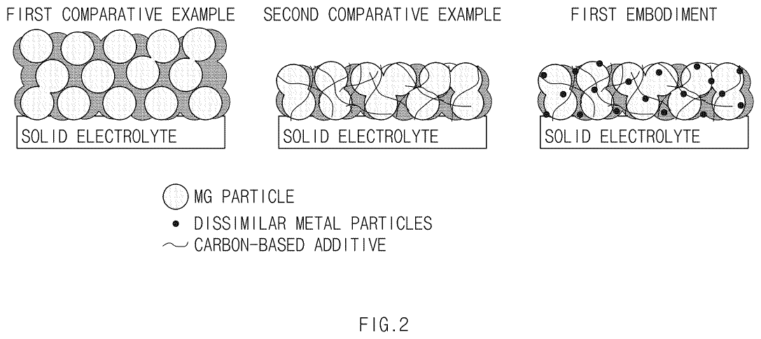

FIG. 3 illustrates potentials according to capacities of batteries of a first embodiment and a fourth comparative example;

FIG. 4 illustrates a Coulombic efficiency according to the number of charge/discharge cycles of a first embodiment and a second comparative example;

FIG. 4 illustrates an SEM image of an electrode after charging and discharging of a first comparative example;

FIG. 6 illustrates an SEM image of an electrode after charging and discharging of a second comparative example;

FIG. 7 illustrates discharge capacities according to the numbers of charge/discharge cycles of a first embodiment and a first comparative example;

FIG. 8 illustrates a Coulombic efficiency according to the number of charge/discharge cycles of a first embodiment;

FIG. 9 illustrates a Coulombic efficiency according to the number of charge/discharge cycles of a third embodiment; and

FIG. 10 illustrates potentials according to capacities of batteries of a first embodiment, a second embodiment, and a third comparative example.

### DETAILED DESCRIPTION

Hereinafter, the present disclosure is described in more detail to help understanding of the present disclosure.

Terms or words used in the detailed description of the present disclosure and the claims should not be interpreted as being limited to ordinary or dictionary meanings. The terms or words should be interpreted as meanings and concepts that are consistent with the technical idea of the present disclosure.

### Electrode

The present disclosure includes a current collector and a coating layer that is located on the current collector. The coating layer includes magnesium particles, metal nanoparticles of a different kind from the magnesium particles, and a carbon material. A weight ratio of the magnesium particles to the metal nanoparticles of the different kind from the magnesium particles is 2.3 to 99:1.

The current collector serves as a substrate, by which a coating layer of an electrode may be supported, while providing an electrical conductivity of the electrode. The current collector has to be a material having a specific level of durability or h above the specific level of durability.

The current collector includes a copper current collector, a stainless steel current collector, an aluminum current collector, a nickel current collector, a titanium current collector, an aluminum-cadmium composite current collector, a nickel plated foil current collector, a nickel alloy current collector, or a combination thereof. Furthermore, the current collector may have a form, such as a film, a sheet, a foil, a net, a porous material, a foam, a nonwoven fabric, and the like to uniformly form a coating layer on a surface thereof.

According to an embodiment of the present disclosure, a thickness of the current collector may be 10 μm to 20 μm. More specifically, the thickness of the current collector may be equal to or larger (i.e., greater) than 10.0 μm, 10.5 μm, 11.0 μm, 11.5 μm, 12.5 μm, 13 μm, 13.5 μm, 14.0 μm, 14.5 μm, or 15.0 μm. The thickness of the current collector may be equal to or smaller (i.e., less) than 20.0 μm, 19.5 μm, 19.0 μm, 18.5 μm, 18.0 μm, 17.5 μm, 17.0 μm, 16.5 μm, 16.0 μm, or 15.5 μm. When the current collector has the thickness within the above range, an electrical resistance may be reduced and a mechanical stability may be improved. Thus, an electrochemical performance and a durability of an electrode may be improved.

The coating layer is formed on the current collector described above. The coating layer may prevent corrosion of the electrode, may improve the conductivity, and may protect the electrode from physical and chemical damages by controlling a chemical reaction between the electrode and the electrolyte.

Specifically, the coating layer improves the electrochemical stability of the electrode to prevent the electrode from corroding or causing unnecessary side reactions with the electrolyte and to improve the life characteristics of the electrode. Furthermore, the coating layer above may maintain a structural integration of the electrode by mitigating physical damage generated during the charging and discharging process and improving a coupling force between particles. In particular, the coating layer having an ion conductivity provides an ion diffusion path to optimize the uniformity and speed of a reaction and may promote or control an electrochemical reaction. Furthermore, the coating layer may increase an energy efficiency by reducing an interfacial resistance between an electrode and an electrolyte.

According to one embodiment of the present disclosure, the thickness of the coating layer may be 4.0 μm to 5.0 μm. More specifically, the thickness of the coating layer may be equal to or larger than 4.0 μm, 4.1 μm, 4.2 μm, 4.3 μm, 4.4 μm, or 4.5 μm. The thickness of the coating layer may be equal to or smaller than 5.0 μm, 4.9 μm, 4.8 μm, 4.7 μm, or 4.6 μm. When the thickness of the coating layer satisfies the above range, the electrical resistance of the coating layer may be maintained to be lower. Thus, the ion conductivity may be further improved, and the mechanical stability of the electrode may be further improved.

Unlike other metal particles, the magnesium particles induce a unique lithium deposition behavior when the battery is driven. Specifically, in the case of other metal particles, compared to lithium being deposited in a layered form on the coating layer, the magnesium particles allow lithium to be deposited between the magnesium particles in the coating layer to generate an expansion behavior of the electrode. This expansion behavior maintains a physical contact between the electrode and the solid electrolyte and may serve to suppress interface deterioration. On the other hand, general layered lithium deposition may cause separation of the solid electrolyte and the electrode interface and thus may cause deterioration of the solid electrolyte. The coating layer containing the magnesium particles may prevent such problems to maintain the stability of the interface, consistently maintain contact between the electrode and the solid electrolyte by suppressing the interface deterioration, and significantly improve the cycle life and stability of the battery. This makes the life characteristics of the electrode very stable, and consequently, a high coulombic efficiency of 99.9% or more than 99.9% may be achieved. The high coulombic efficiency means that there is little loss of charge during the charging and discharging process of the battery and maximizes the energy efficiency of the battery. Accordingly, the electrode including the coating layer containing the magnesium particles may have a long life such that a full-cell driving is performed for 1,000 cycles or more than 1,000 cycles.

The average particle diameter of the magnesium particles is a particle size at a point of 50% of a cumulative volume distribution according to the particle size of magnesium particles that are present in the coating layer and may be 500 nm to 1000 nm. More specifically, the average particle diameter of the magnesium particles may be equal to or larger than 500 nm, 550 nm, 600 nm, 650 nm, 700 nm, or 750 nm. The average particle diameter of the magnesium particles may be equal to or smaller than 1000 nm, 950 nm, 900 nm or 850 nm, or 800 nm. When the average particle diameter of the magnesium particles satisfies the above range, the diffusion path of the lithium ions may be optimized to further improve the rate capability characteristics of the electrode, and the electrochemical reaction area may be appropriately maintained. Accordingly, when the average particle diameter of the magnesium particles is adjusted within the above range, the uniformity of performance of the electrode may be improved, and thus a stable performance even in large-scale production may be ensured. In the present disclosure, the “average particle diameter” means a particle diameter at a point of 50% of the cumulative volume distribution according to the particle diameter. The average particle diameter may be measured by dispersing the powder to be measured in a dispersion medium and introducing the powder into a commercially available laser diffraction particle size measurement device. Thus, a particle size distribution may be calculated by measuring a diffraction pattern difference according to a particle size when the particles pass through the laser beam, and by calculating a particle diameter at a point of 50% of a cumulative volume distribution according to the particle size in the measurement device.

On the other hand, due to the low lithium dynamic properties of the magnesium material, as the current density becomes higher, the lithium deposition behavior becomes more uneven, and low rate capability characteristics and capacity maintenance characteristics may appear. In other words, because the coating layer containing magnesium has a lower ability to maintain a uniform and stable lithium deposition behavior, i.e., an expansion behavior, as the current density becomes higher, the lifespan characteristics become worse.

To solve this, the coating layer including the magnesium particles of the present disclosure includes metal nanoparticles of a different kind from the magnesium particles. Specifically, the metal nanoparticles of a different kind from the magnesium particles may increase the movement speed of lithium ions and thus may improve the rate capability characteristics of the electrode and may make lithium deposition more uniform even when the current density is high. Furthermore, the metal nanoparticles of a different kind from the magnesium particles may adjust a surface structure of the electrode to uniformly deposit lithium. As a result, the capacity maintenance rate and lifespan characteristics of the electrode may be improved, and various metal nanoparticles may provide different electrochemical properties to increase the overall performance of the electrode and secure a long-term stability.

According to an embodiment of the present disclosure, the metal nanoparticles of the different kind from the magnesium particles include silver nanoparticles, tin nanoparticles, zinc nanoparticles, bismuth nanoparticles, indium nanoparticles, gallium nanoparticles, or a combination thereof.

According to one embodiment of the present disclosure, the average particle diameter of the metal nanoparticles of the different kind from the magnesium particles may be 30 nm to 800 nm. More specifically, the average particle diameter of the metal nanoparticles of the different kind from the magnesium particles may be equal to or larger than 30 nm, 40 nm, 50 nm, 60 nm, 70 nm, 80 nm, 90 nm, 100 nm, 110 nm, 120 nm, 130 nm, 140 nm, 150 nm, 160 nm, 170 nm, 180 nm, 190 nm, 200 nm, 210 nm, 220 nm, 230 nm, 240 nm, 250 nm, 260 nm, 270 nm, 280 nm, 290 nm, 300 nm, 310 nm, 320 nm, 330 nm, 340 nm, 350 nm, 360 nm, 370 nm, 380 nm, 390 nm, or 400 nm. The average particle diameter of the metal nanoparticles of the different kind from the magnesium particles may be equal to or smaller than 800 nm, 790 nm, 780 nm, 770 nm, 760 nm, 750 nm, 740 nm, 730 nm, 720 nm, 710 nm, 700 nm, 690 nm, 680 nm, 670 nm, 660 nm, 650 nm, 640 nm, 630 nm, 620 nm, 610 nm, 600 nm, 590 nm, 580 nm, 570 nm, 560 nm, 550 nm, 540 nm, 530 nm, 520 nm, 510 nm, 500 nm, 490 nm, 480 nm, 470 nm, 460 nm, 450 nm, 440 nm, 430 nm, 420 nm, or 410 nm. When the average particle diameter of the metal nanoparticles of the different kind from the magnesium particles satisfies the above range, a balance, such as a capacity, a conductivity, a durability, and the like of the electrode may be optimized. Specifically, as the average particle diameter of the metal nanoparticles of the different kind from the magnesium particles becomes smaller, the structural stability of the electrode becomes higher, and the durability and resistance are improved to provide a stable performance for a long time. Furthermore, the metal nanoparticles of the different kind from the magnesium particles may be more uniformly distributed between the magnesium particles to induce a uniform expansion behavior.

In the coating layer, the metal nanoparticles or the metal nanoparticles of the different kind from the magnesium particles may be present and dispersed between the magnesium particles. Specifically, the metal nanoparticles of the different kind from the magnesium particles may be present and uniformly dispersed between the magnesium particles throughout the coating layer. Such a uniform distribution may increase the overall surface area, thereby improving the reaction speed and efficiency, further improving the conductivity of the electrode, and further increasing the structural stability of the electrode to maintain the performance even during a long-term use. In particular, the uniform distribution of the metal nanoparticles of a different kind from the magnesium particles may secure the uniformity of the reactivity and the conductivity of the electrode and thus may further improve the stability of the electrode performance.

The carbon material is introduced to improve the low lithium dynamic properties of the magnesium material, and without the carbon material, lithium may be unevenly deposited on the electrode surface due to the insufficient movement path of lithium ions. This may lead to short circuits and performance degradation of cells by causing a lithium dendritic growth, an interface degradation, and penetration of the solid electrolyte. Furthermore, as the lithium mobility decreases, the rate capability characteristics of the battery decrease during fast charging and discharging, and initial irreversible properties may also deteriorate. This may lead to a decrease in an initial efficiency and a shortened lifespan of the battery.

According to an embodiment of the present disclosure, the carbon material may be carbon nanotubes, vapor-grown carbon fibers, or a combination thereof.

In the coating layer above, the carbon material may be present and dispersed between the magnesium particles. Specifically, the carbon material may be present and uniformly dispersed between the magnesium particles throughout the coating layer. In this case, the movement path of lithium ions may be uniformly formed so that lithium may be uniformly deposited. Furthermore, the carbon material that is present and uniformly dispersed between the magnesium particles may form a conductive network to maintain the performance even during fast charging and discharging. Thus, the rate capability characteristics may be improved.

According to one embodiment of the present disclosure, the thickness of the electrode may be 14.0 μm to 15.0 μm. More specifically, the thickness of the electrode may be equal to or larger than 14.0 μm, 14.1 μm, 14.2 μm, 14.3 μm, 14.4 μm, or 14.5 μm. The thickness of the electrode may be equal to or smaller than 15.0 μm, 14.9 μm, 14.8 μm, 14.7 μm, or 14.6 μm. When the thickness of the electrode satisfies the above range, a sufficient storage capacity and a high energy density of the electrode may be provided to secure a more efficient performance in the energy storage device. Furthermore, when the range of the thickness of the electrode is satisfied, heat may be more uniformly dispersed to prevent overheating and further increase the stability of the electrode. A physical durability and a chemical stability may also be improved to further improve the life of the electrode.

According to one embodiment of the present disclosure, the weight ratio of the magnesium particles to the metal nanoparticles of the different kind from the magnesium particles is 2.3:1 to 99:1. More specifically, the weight ratio of the magnesium particles to the metal nanoparticles of the different kind from the magnesium particles may be equal to or larger than 2.3:1, 5.0:1, 7.5:1, 10.0:1, 12.5:1, 15.0:1, 17.5:1, 20.0:1, 22.5:1, 25.0:1, 27.5:1, 30.0:1, 32.5:1, 35.0:1, 37.5:1, 40.0:1, 42.5:1, 45:1, 47.5:1, or 50.0:1. The weight ratio of the magnesium particles to the metal nanoparticles of the different kind from the magnesium particles may be equal to or smaller than 99.0:1, 97.5:1, 95.0:1, 92.5:1, 90.0:1, 87.5:1, 85.0:1, 82.5:1, 80.0:1, 77.5:1, 75.0:1, 72.5:1, 70.0:1, 67.5:1, 65.0:1, 62.5:1, 60.0:1, 57.5:1, 55.0:1, or 52.5:1. When the weight ratio range of the magnesium particles and the metal nanoparticles of the different kind from the magnesium particles above is satisfied, the expansion behavior and stability of the electrode may be secured. When the weight ratio does not satisfy the above range, a uniform expansion behavior does not appear during deposition of the lithium ions, and unnecessary cracks are caused in the electrode layer. This makes stable deposition and desorption of lithium impossible. Furthermore, when the weight ratio does not satisfy the above range, the conductivity and the electrochemical reaction speed of the electrode decrease, and the storage capacity and the performance of the electrode deteriorate.

According to an embodiment of the present disclosure, the carbon material may be included in the coating layer in an amount of 0.1 wt % to 10 wt %. More specifically, the carbon material may be included in the coating layer in an amount equal to or larger than 0.1 wt %, 0.5 wt %, 1.0 wt %, 1.5 wt %, 2.0 wt %, 3.0 wt %, 3.5 wt %, 4.0 wt %, 4.5 wt %, or 5.0 wt %. The carbon material may be included in an amount equal to or smaller than 10.0 wt %, 9.5 wt %, 9.0 wt %, 8.5 wt %, 8.0 wt %, 7.5 wt %, 7.0 wt %, 6.0 wt %, or 5.5 wt %. When the content of the carbon material satisfies the above range, lithium may be stably deposited and desorbed, and the expansion behavior of the electrode may occur more smoothly.

In addition to the magnesium particles, the metal nanoparticles of the different kind from the magnesium particles, and the carbon material, the coating layer may include a dispersant that helps the particles in the coating layer to be uniformly dispersed, or the coating layer may include a stabilizer that provides stability so that the nanoparticles do not aggregate. In addition, the coating layer may include a binder that allows the nanoparticles to be attached to each other or to the current collector.

### Method for Manufacturing Electrode

The present disclosure provides a method for manufacturing an electrode. The method includes (S1) an operation of manufacturing a coating solution by mixing magnesium particles, a carbon material, metal nanoparticles of a different kind from the magnesium particles, a binder, and a solvent. The method also includes (S2) an operation of forming a coating layer on a surface of a current collector by using the coating solution. The method also includes (S3) an operation of drying the coating layer at a temperature of 100° C. to 150° C., and a weight ratio of the magnesium particles and the metal nanoparticles of the different kind from the magnesium particles of 2.3 to 99:1.

In operation S1, the binder is a component that aids in coupling of the magnesium particles, the metal nanoparticles of the different kind from the magnesium particles, and the current collector. The binder may be added in an amount of about 0.1 wt % to about 10 wt % with respect to the total weight of the coating solution. Examples of such binders may include polyvinylidene fluoride (PVDF), polyvinyl alcohol, carboxymethyl cellulose (CMC), starch, hydroxypropyl cellulose, regenerated cellulose, polyvinyl pyrrolidone, polytetrafluoroethylene, polyethylene, polypropylene, ethylene-propylene-diene polymer (EPDM), sulfonated-EPDM, styrene-butadiene rubber, nitrile-butadiene rubber, fluoroelastomer, and various copolymers thereof.

In operation S1, the solvent may be selected from solvents that do not affect the magnesium particles, the metal nanoparticles of the different kind from the magnesium particles, and the current collector. Specific examples thereof may include dimethyl sulfoxide (DMSO), isopropyl alcohol, N-methylpyrrolidone (NMP), dimethylformamide (DMF), acetone, or water, and one of these alone or a mixture of two or more thereof may be used. The solvent may be used to dissolve or disperse the magnesium particles, the metal nanoparticles of the different kind from the magnesium particles, and a binder in consideration of the coating thickness and the production yield rate of the coating solution and a viscosity that may exhibit an excellent thickness uniformity when applied for manufacturing the anode is sufficient.

In operation S2, the magnesium, the metal nanoparticles of the different kind from the magnesium, or the carbon material may be present and dispersed between the magnesium particles in the coating layer. The dispersion of the magnesium, the metal nanoparticles of the different kind from the magnesium particles, or the carbon material may be achieved through physical dispersion (such as a high-speed mixer, an ultrasonic processor, or a vibration stirrer), chemical dispersion using a dispersant, dispersion through a high-temperature and high-pressure process or gas injection, or dispersion through a high-temperature heat treatment or an emulsification method.

In operation S2, the coating layer may be formed by applying the coating solution onto the current collector and drying the current collector, or by casting the coating solution on a separate support body and then laminating a film obtained through delamination from the support body on the current collector.

In operation S3, the coating layer is dried within a specific temperature range, and thus the quality and performance of the electrode may be secured. Specifically, during drying at a too high temperature, the components in the coating layer may not be uniform or cracks may occur, and during drying at a too low temperature, drying may be incomplete. Furthermore, drying at an appropriate temperature may improve the mechanical properties of the coating layer to increase a resistance to physical damage. Thus, the quality consistency during mass production may be maintained, and the overall performance of the electrode may be stably secured.

According to one embodiment of the present disclosure, the drying temperature in operation S3 is 100° C. to 150° C. More specifically, the drying temperature in operation S3 described above may be equal to or higher than 100° C., 101° C., 102° C., 103° C., 104° C., 105° C., 106° C., 107° C., 108° C., 109° C., 110° C., 111° C., 112° C., 113° C., 114° C., 115° C., 116° C., 117° C., 118° C., 119° C., 120° C., 121° C., 122° C., 123° C., 124° C., or 125° C. The drying temperature in operation S3 described above may be equal to or lower than 150° C., 149° C., 148° C., 147° C., 146° C., 145° C., 144° C., 143° C., 142° C., 141° C., 140° C., 139° C., 138° C., 137° C., 136° C., 135° C., 134° C., 133° C., 132° C., 131° C., 130° C., 129° C., 128° C., 127° C., or 126° C. When the drying temperature satisfies the above range, the coating layer may be uniformly dried to form a structure, in which the magnesium particles and the nanoparticles are stably and uniformly coupled to each other. Thus, the uniformity of the coating layer and the coupling force of the particles may be improved.

According to an embodiment of the present disclosure, operation S3 may be performed for 5 hours to 8 hours. More specifically, operation S3 may be performed for a time period equal to or longer than 5.0 hours, 5.2 hours, 5.4 hours, 5.6 hours, 5.8 hours, 6.0 hours, 6.2 hours, or 6.4 hours. Operation S3 may be performed for a time period equal to or shorter than 8.0 hours, 7.8 hours, 7.6 hours, 7.4 hours, 7.2 hours, 7.0 hours, 6.8 hours, or 6.6 hours. When drying of operation S3 is performed for the above time period, the coating layer may improve a drying uniformity. Thus, the physical properties of the coating layer, i.e., a density and a strength, may be optimized. A chemical stability may be maintained. This may improve electrical performance and may further increase the mechanical robustness of the coating layer.

### Anode-Free All-Solid-State Battery

The present disclosure provides an anode-free all-solid-state battery that includes a cathode, an anode, and a solid electrolyte layer that is disposed between the cathode and the anode. The cathode includes a cathode active material layer containing a cathode active material, the anode is the electrode described above (i.e., the electrode of claim 1 below), and the solid electrolyte layer is disposed between the cathode active material layer and the anode.

The cathode may include a cathode current collector, and a cathode active material layer that is located on the cathode current collector.

The cathode current collector is not particularly limited as long as the cathode current collector may include a highly conductive metal, the cathode active material layer is easily adhered, and the cathode current collector is not reactive in the voltage range of the battery. A cathode current collector that is obtained by surface-treating stainless steel, aluminum, nickel, titanium, fired carbon, or a surface of aluminum or stainless steel with carbon, nickel, titanium, silver, or the like may be used. Furthermore, the cathode current collector may generally have a thickness of 3 μm to 500 μm, and the adhesion force of the cathode active material may be increased by forming fine convexo-concaves (i.e., convexo-concave structures) on the surface of the current collector. For example, the cathode current collector may be used in various forms, such as films, sheets, foils, nets, porous bodies, foams, and nonwoven fabrics.

The cathode active material layer may optionally include a conductive material and a binder as needed, together with the cathode active material. The cathode active material may be LiCoO₂, LiCoPO₄, LiNiO₂, LiₓNiₐCo_{b}M¹_{c}M²_{d}O₂ (where M¹ and M² are each independently selected from the group consisting of Al, Mn, Cu, Fe, V, Cr, Mo, Ga, B, W, Mo, Nb, Mg, Hf, Ta, La, Ti, Sr, Ba, Ce, F, P, S, and Y, and where 0.9≤x≤1.1, 0<a<1.0, 0<b<1.0, 0≤c<0.5, 0≤d<0.5, and a+b+c+d=1), LiMnO₂, LiMnO₃, LiMn₂O₃, LiMn₂O₄, LiMn₂-eM³eO₂ (where M³ is selected from the group consisting of Co, Ni, Fe, Cr, Zn, and Ta, and where 0.01≤e≤0.1), Li₂Mn₃M⁴O₈ (where M⁴ is selected from the group consisting of Ci, Ni, Fe, Cu, and Zn), LiFePO₄, Li₂CuO₂, LiV₃O₈, V₂O₅, Cu₂V₂O₇, a lithium metal, or a combination thereof.

The binder of the cathode active material layer serves to improve an attachment between cathode active material particles and an adhesion force of the cathode active material and the current collector. Specific examples include polyvinylidene fluoride (PVDF), polyvinylidene fluoride-hexafluoropropylene copolymer (PVDF-co-HFP), polyvinylalcohol, polyacrylonitrile, polymethyl methacrylate, carboxymethyl cellulose (CMC), starch, hydroxypropyl cellulose, regenerated cellulose, polyvinyl pyrrolidone, polytetrafluoroethylene, polyethylene, polypropylene, ethylene-propylene-diene polymer (EPDM), sulfonated-EPDM, styrene butadiene rubber (SBR), fluoroelastomer, polyacrylic acid, and polymers, in which hydrogens thereof are substituted with Li, Na, or Ca, or various copolymers thereof, and one of them alone or a mixture of two or more thereof may be used. The binder may be included in an amount of 0.1 wt % to 15 wt % with respect to the total weight of the cathode active material layer.

The conductive material of the cathode active material layer is used to impart a conductivity to the electrode, and in the configured battery, any material having an electronic conductivity without causing a chemical change may be used without particular limitation. Specific examples include graphite (such as natural graphite or artificial graphite), carbon-based materials (such as carbon black, acetylene black, Ketjen black, channel black, furnace black, lamp black, thermal black, and carbon fiber), metal powders or metal fibers (such as copper, nickel, aluminum, and silver), conductive tubes (such as carbon nanotubes), conductive whiskers (such as zinc oxide or potassium titanate), conductive metal oxides (such as titanium oxide), or conductive polymers (such as polyphenylene derivatives, and the like), and one of them alone or two or more thereof may be used. The conductive material may be included in an amount of 0.1 wt % to 15 wt % with respect to the total weight of the cathode active material layer.

The cathode may be manufactured through a general cathode manufacturing method. Specifically, the cathode may be manufactured by applying the cathode active material and the composition for forming the cathode active material layer onto the cathode current collector. The cathode active material layer is manufactured by selectively dissolving or dispersing the binder, the conductive material, and the dispersant in the solvent, if necessary. The cathode may be manufactured by drying and rolling. The cathode current collector may be manufactured by casting the composition for forming the cathode active material layer on a separate support body and then laminating a film obtained through delamination from the support body on the cathode current collector.

The solvent may be a solvent generally used in the relevant technical field and may include dimethyl sulfoxide (DMSO), isopropyl alcohol, N-methylpyrrolidone (NMP), dimethylformamide (DMF), acetone, or water, and one of these alone, or a mixture of two or more thereof may be used. The amount of the solvent used is sufficient as long as the solvent dissolves or disperses the cathode active material, the conductive material, the binder, and the dispersant, in consideration of the coating thickness and the production yield rate of the slurry, and the solvent has a viscosity that may exhibit an excellent thickness uniformity during subsequent coating for manufacturing the cathode.

The solid electrolyte layer may include a polymer electrolyte, an oxide-based solid electrolyte, a sulfide-based solid electrolyte, or a combination thereof, and in one example may include a sulfide-based solid electrolyte.

The anode-free all-solid-state battery may exhibit a sufficient expansion behavior when charging and discharging are performed 100 or more times, and thus lithium may be present and dispersed between the magnesium particles. Specifically, lithium may not be unevenly deposited in one position as a lump, but may be uniformly dispersed and distributed between the magnesium particles in a specific size.

The exterior of the anode-free all-solid-state battery of the present disclosure is not particularly limited, but may have a cylindrical shape, using a can, a prismatic shape, a pouch shape, or a coin shape.

The anode-free all-solid-state battery according to the present disclosure may be used in a battery cell used as a power source of a small device and may be used as a unit cell in a middle or large-sized battery module including a plurality of battery cells.

Accordingly, a battery module including the anode-free all-solid-state battery as a unit cell and a battery pack including the same are provided.

The battery module or the battery pack may be used as a medium or large-sized device power source at least one of a power tool, an electric vehicle including an EV, a hybrid electric vehicle, a plug-in hybrid electric vehicle (PHEV), or a power storage system.

Hereinafter, embodiments of the present disclosure are described in detail so that a person having ordinary skill in the art, to which the present disclosure pertains, may easily practice the present disclosure. However, the present disclosure may be implemented in various different forms and is not limited to the embodiments described herein.

### <Manufacturing of Electrode>

### First Embodiment (Mg:Sn:CNT=85.5:9.5:5)

In one embodiment, 0.045 g of magnesium (Mg) powder, 0.005 g of tin (Sn) powder, 0.0025 g of carbon nanotubes, 0.001282 g of polyvinylidene fluoride (PVDF), and 0.0083 mL of N-methyl-2-pyrrolidone (NMP) were put into a ball mill container. Zirconia balls with a size of 10 mm were placed and treated at a rotational speed of 35 RPM for 15 minutes at room temperature to manufacture a coating solution. The manufactured coating solution was applied onto a stainless steel current collector of a size of 6 cm×10 cm by using a 70 μm-gap blade and was dried at 120° C. for 360 minutes to manufacture an electrode.

### Second Embodiment (Mg:Sn:CNT-88:10:2)

In another embodiment, an electrode was manufactured in the same manner as in the first embodiment, except that 0.0449 g of magnesium (Mg) powder, 0.0051 g of tin (Sn) powder, and 0.001 g of carbon nanotube were added.

### Third Embodiment (Mg:Sn:VGCF=85.5:9.5:5)

In yet another embodiment, an electrode was manufactured in the same manner as in the first embodiment, except that 0.0025 g of vapor-grown carbon fiber (VGCF) was used instead of carbon nanotubes (CNT) in the first embodiment.

### First Comparative Example

In one example, an electrode was manufactured in the same manner as in the first embodiment, except that tin (Sn) powder and carbon nanotubes (CNT) were not added.

### Second Comparative Example

In another example, an electrode was manufactured in the same manner as in the first embodiment, except that tin (Sn) powder was not added.

### Third Comparative Example (Mg:Sn:CNT=55:5:40)

In yet another example, an electrode was manufactured in the same manner as in the first embodiment, except that 0.04583 g of magnesium (Mg) powder, 0.00417 g of tin (Sn) powder, and 0.0333 g of carbon nanotube were added.

### Fourth Comparative Example

In yet still another example, an electrode was manufactured in the same manner as in the first embodiment, except that carbon nanotubes (CNT) were not added.

### <Manufacturing of Half Cells of Anode-Free All-Solid-State Battery>

In one example, 90 mg of Li6PS5Cl0.5Br0.5 was put into a mold with an inner diameter of 10 mm and compressed at 200 MPa to manufacture a solid electrolyte layer. The electrodes manufactured in the embodiments and the comparative examples were used as an anode. The manufactured solid electrolyte layer and the anode were pressed together at 380 MPa such that the anode and the solid electrolyte layer contact each other. Finally, a lithium metal having a thickness of 400 μm was brought into contact with an opposite side to the anode with respect to the solid electrolyte layer as the cathode and then pressed at 5 MPa to manufacture half cells of the anode-free all-solid-state battery.

### <Manufacturing of Full Cells of Anode-Free All-Solid-State Battery>

In one example, 90 mg of Li6PS5Cl0.5Br0.5 was put into a mold with an inner diameter of 10 mm and compressed at 200 MPa to manufacture a solid electrolyte layer. The electrodes manufactured in the embodiments and the comparative examples were used as an anode. The manufactured solid electrolyte layer and the anode were pressed together at 380 MPa such that the anode and the solid electrolyte layer contact each other. Finally, 20 mg of the powder mixed to have a weight ratio of NCM 811:Li6PS5Cl0.5Br0.5:VGCF (VGCF) of 70:30:3 was stacked on an opposite side to the anode with respect to the solid electrolyte layer and compressed at 200 MPa to manufacture full cells of an anode-free all-solid-state battery.

### First Experimental Example: Evaluation of Lifespan Characteristics by Presence of Carbon Material

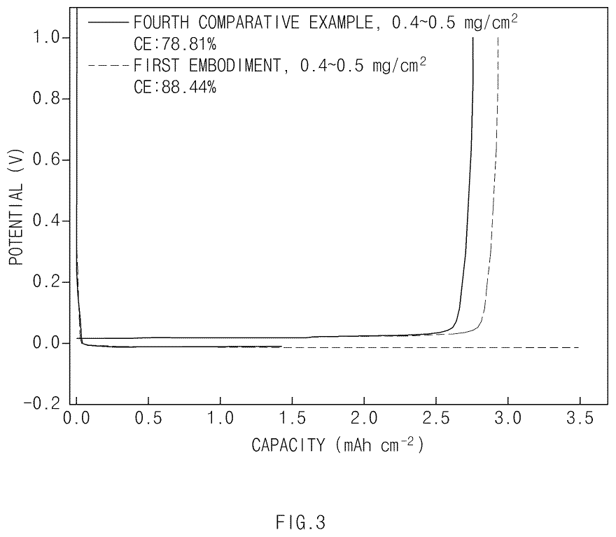

For half cells of the anode-free all-solid-state batteries including the electrodes of the first embodiment and the fourth comparative example, respectively, when discharging was performed for 4 hours under the conditions of a current density of 0.5 mA/cm² and a capacity of 2 mAh/cm², and then charging and discharging were performed 160 times under the conditions of an end-of-charge voltage of 1 V, a current of 0.25 C, a current density of 0.5 mA/cm², and a capacity of 2 mAh/cm², the potential according to the capacity of the battery was measured, and the results are illustrated in FIG. 3.

As illustrated in FIG. 3, it may be seen that the electrode (a coulombic efficiency: 88.44%) of the first embodiment has a higher coulombic efficiency than the electrode of the fourth comparative sample (a coulombic efficiency: 78.81%).

### Second Experimental Example: Evaluation of Lifespan Characteristics of Metal Nanoparticles of a Different Kind from Magnesium Particles

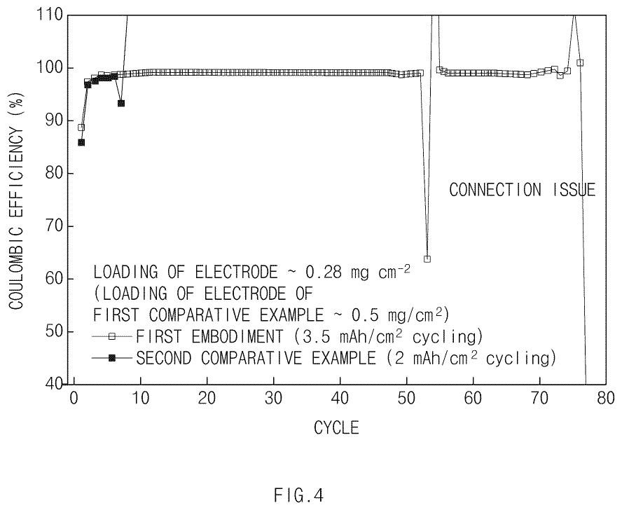

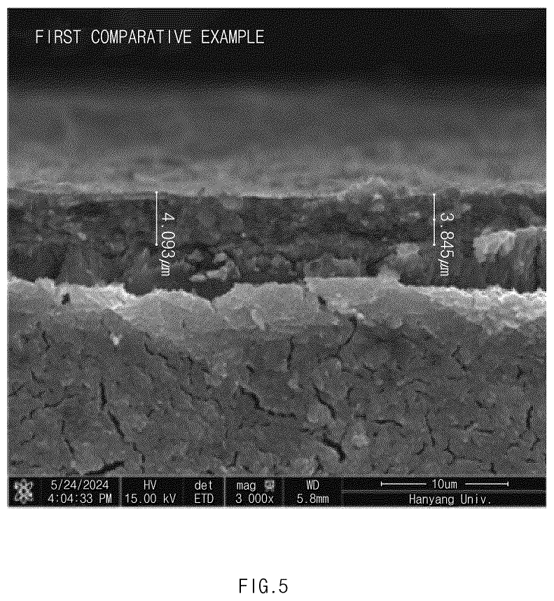

For half cells of the anode-free all-solid-state batteries including the electrodes of the first embodiment and the second comparative example, respectively, when discharging was performed for 4 hours under the conditions of a current density of 0.5 mA/cm² and a capacity of 2 mAh/cm², and then charging and discharging were performed 80 times under the conditions of an end-of-charge voltage of 1 V, a current of 0.25 C, a current density of 0.5 mA/cm², and a capacity of 2 mAh/cm², the potential according to the capacity of the battery was measured, and the results are illustrated in FIG. 4.

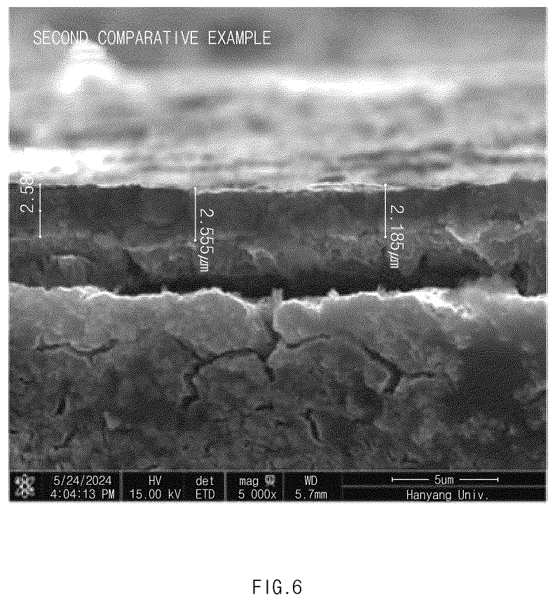

As illustrated in FIG. 4, because both the first embodiment and the second comparative example contain carbon nanotubes as a carbon material, the physical properties of the electrode slurry are improved, and the electrode loading may be minimized. However, in the second comparative example, when the electrode loading is minimized, the electrode thickness is thinner than in the first comparative example that does not contain a carbon material (see FIGS. 5 and 6), and it may be identified that the long-term lifespan characteristics are degraded while a problem of a decrease in the effect of stabilizing lithium deposition occurs.

However, in the half cells of the anode-free all-solid-state battery including the electrode of the first embodiment, it was possible to drive more than 75 cycles despite the low electrode loading, the high current density, and the high capacity environment due to the effect of stabilizing lithium deposition of the metal nanoparticles of the different kind from the magnesium particles. Through this, it was identified that the initial irreversibility and the current density robustness were improved while maintaining the long-term lifespan characteristics of the electrode by using a carbon material and the metal nanoparticles of a different kind from the magnesium particles.

### Third Experimental Example: Evaluation of Rate Capability Characteristics

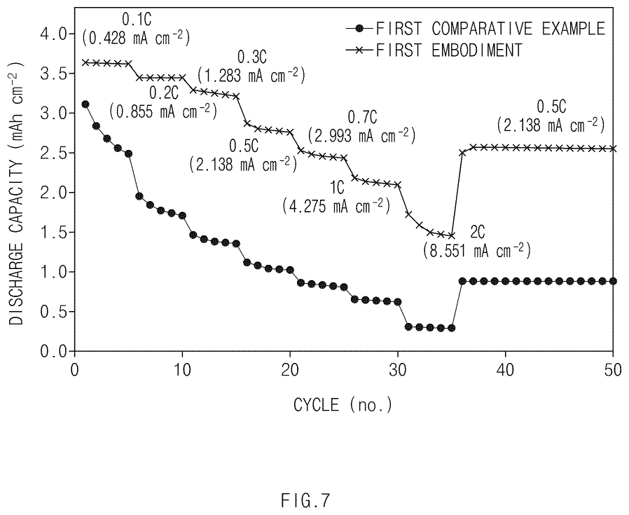

For full cells of the anode-free all-solid-state batteries including the electrodes of the first embodiment and the first comparative example, respectively, when discharging was performed for 4 hours under the conditions of a current density of 0.5 mA/cm² and a capacity of 2 mAh/cm², and then charging and discharging were performed 50 times under the conditions of an end-of-charge voltage of 1 V, a current of 0.25 C, a current density of 0.5 mA/cm², and a capacity of 2 mAh/cm², the discharge capacity according to the number of charging/discharging cycles of the battery was measured, and the results are illustrated in FIG. 7.

As may be seen from FIG. 7, the electrode of the first embodiment greatly improves initial irreversible rate capability characteristics compared to the electrode of the first comparative example.

### Fourth Experimental Example: Evaluation of Lifespan Characteristics by Kind of Carbon Material

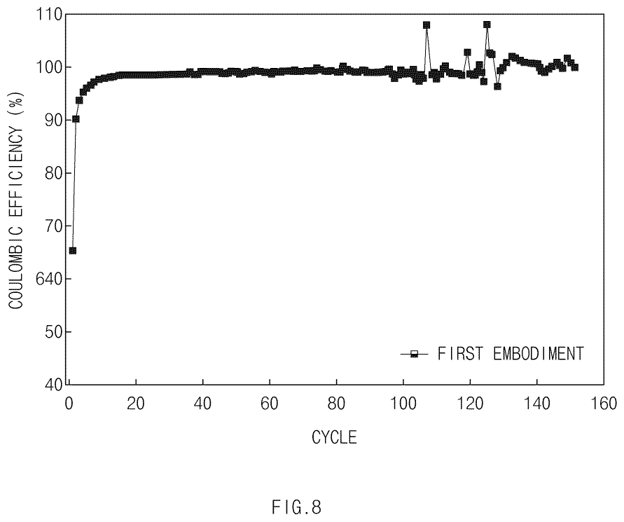

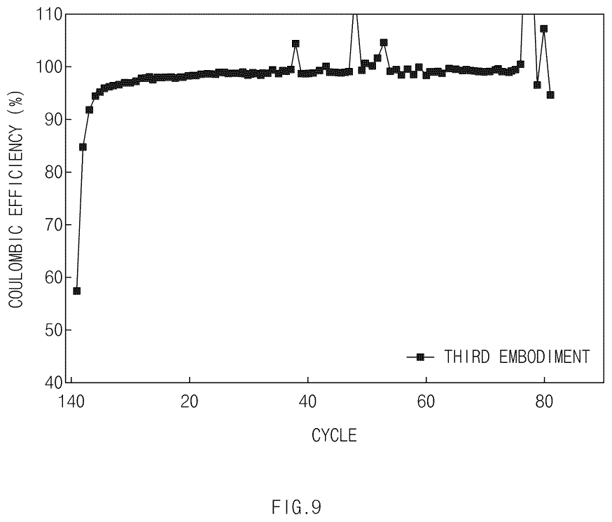

For half cells of the anode-free all-solid-state batteries including the electrodes of the first embodiment and the third comparative example, respectively, when discharging was performed for 4 hours under the conditions of a current density of 0.5 mA/cm² and a capacity of 2 mAh/cm², and then charging and discharging were performed 80 times under the conditions of an end-of-charge voltage of 1 V, a current of 0.25 C, a current density of 0.5 mA/cm², and a capacity of 2 mAh/cm², the Column capacity according to the number of charging/discharging cycles of the battery was measured, and the results are illustrated in FIGS. 8 and 9.

According to the illustration of FIG. 8 and FIG. 9, even when a linear carbon structure, such as a vapor-grown carbon fiber, as well as carbon nanotubes as a carbon material, excellent lifespan characteristic results were illustrated.

### Fifth Experimental Example: Evaluation of Lifespan Characteristics According to Contents of Magnesium Particles, Metal Nanoparticles of a Different Kind from the Magnesium Particles, and Carbon Material

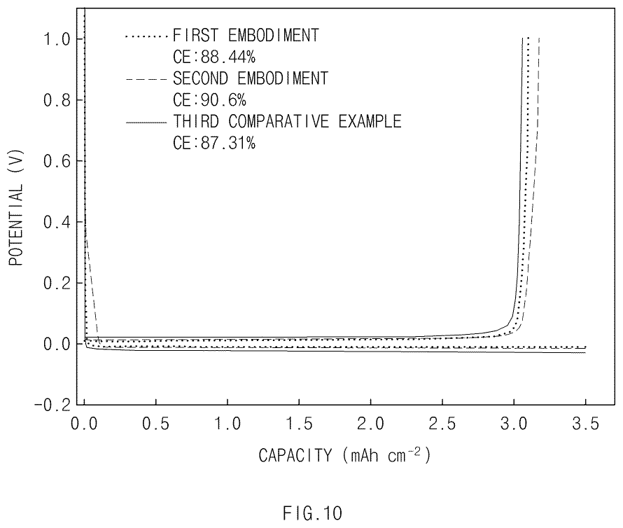

For half cells of the anode-free all-solid-state batteries including the electrodes of the first embodiment, the second embodiment, and the third comparative example, respectively, when discharging was performed for 4 hours under the conditions of a current density of 0.5 mA/cm² and a capacity of 2 mAh/cm², and then charging and discharging were performed 100 times under the conditions of an end-of-charge voltage of 1 V, a current of 0.25 C, a current density of 0.5 mA/cm², and a capacity of 2 mAh/cm², the potential according to the capacity of the battery was measured, and the results are illustrated in FIG. 10.

Referring to FIG. 10, it may be seen that the coulombic efficiencies (88.44% and 90.60%, respectively) of the electrodes of the first embodiment and the second embodiment were higher than the coulombic efficiency (87.31%) of the electrode of the third comparative example.

The electrode of the present disclosure includes magnesium particles, metal nanoparticles of a different kind from the magnesium particles, and a carbon material. By controlling a weight ratio thereof, a low lithium diffusion rate of magnesium may be supplemented, and movement of lithium ions in the electrode may be expedited to improve rate capability characteristics, and uniform expansion behaviors may be induced to secure the stability of lithium deposition and desorption behaviors.

In addition, because the anode-free all-solid-state battery of the present disclosure includes the electrode according to the present disclosure, lifespan characteristics may be improved.

What is claimed is:

1. An electrode comprising:
a current collector; and
a coating layer located on the current collector,
wherein the coating layer includes magnesium particles, metal nanoparticles of a different kind from the magnesium particles, and a carbon material, and
wherein a weight ratio of the magnesium particles to the metal nanoparticles of the different kind from the magnesium particles is 2.3 to 99.1.

2. The electrode of claim 1, wherein the carbon material is included in the coating layer in an amount of 0.1% by weight to 10% by weight.

3. The electrode of claim 1, wherein the current collector is selected from the group consisting of a copper current collector, a stainless steel current collector, an aluminum current collector, a nickel current collector, a titanium current collector, an aluminum-cadmium composite current collector, a nickel plated foil current collector, and a nickel alloy current collector.

4. The electrode of claim 1, wherein the carbon material is present and dispersed between the magnesium particles.

5. The electrode of claim 1, wherein the carbon material is selected from the group consisting of a carbon nanotube and a vapor-grown carbon fiber.

6. The electrode of claim 1, wherein the metal nanoparticles of the different kind from the magnesium particles are selected from the group consisting of silver nanoparticles, tin nanoparticles, zinc nanoparticles, bismuth nanoparticles, indium nanoparticles, and gallium nanoparticles.

7. The electrode of claim 1, wherein an average particle diameter of the metal nanoparticles of the different kind from the magnesium particles ranges from 30 nm to 800 nm.

8. The electrode of claim 1, wherein a thickness of the coating layer ranges from 4.0 μm to 5.0 μm.

9. The electrode of claim 1, wherein in the coating layer, the metal nanoparticles or the metal nanoparticles of the different kind from the magnesium particles are present and dispersed between the magnesium particles.

10. The electrode of claim 1, wherein a thickness of the electrode ranges from 14.0 μm to 15.0 μm.

11. A method for manufacturing an electrode, the method comprising:
manufacturing a coating solution by mixing magnesium particles, a carbon material, metal nanoparticles of a different kind from the magnesium particles, a binder, and a solvent;
forming a coating layer on a surface of a current collector by using the coating solution; and
drying the coating layer at a temperature of 100° C. to 150° C.,
wherein a weight ratio of the magnesium particles to the metal nanoparticles of the different kind from the magnesium particles is 2.3 to 99.1.

12. The method of claim 11, wherein drying the coating layer is performed for 5 hours to 8 hours.

13. An anode-free all-solid-state battery comprising:
a cathode, an anode, and a solid electrolyte layer disposed between the cathode and the anode,
wherein the cathode includes a cathode active material layer including a cathode active material,
wherein the anode is the electrode of claim 1, and
wherein the solid electrolyte layer is disposed between the cathode active material layer and the anode.

14. The anode-free all-solid-state battery of claim 13, wherein a solid electrolyte of the solid electrolyte layer is selected from the group consisting of a polymer electrolyte, an oxide-based solid electrolyte, and a sulfide-based solid electrolyte.

15. The anode-free all-solid-state battery of claim 13, wherein lithium is present and dispersed between the magnesium particles when the anode-free all-solid-state battery is charged and discharged 100 times or more than 100 times.
